(19) United States
(12) Patent Application Publication
(10) Pub. No.: US 2025/0200297 A1
(43) Pub. Date: Jun. 19, 2025

(54) AUTOMATIC GENERATION OF SUGGESTED EDITS FOR PASTE EVENTS

(71) Applicant: Google LLC, Mountain View, CA (US)

(72) Inventors: Alexander Werner Frömmgen, Östringen (DE); Simone Forte, Zurich (CH); Krzysztof Jacek Gorgolewski, New York, NY (US); Maxim Tabachnyk, Munich (DE)

(21) Appl. No.: 18/544,257

(22) Filed: Dec. 18, 2023

(51) Int. Cl. G06F 40/40; G06F 40/166

(52) U.S. Cl. CPC G06F 40/40; G06F 40/166

(57) ABSTRACT

Methods, systems, and apparatus, including computer programs encoded on a computer storage medium, for automatic generation of suggested edits for paste events. In one aspect, a method comprises receiving information comprising a text segment to be inserted into a body of text displayed in a user interface, identifying a context, where the context is based at least in part on text surrounding the inserted text segment in the body of text, generation an input that comprises the text segment and the context, processing the input using a trained neural network to generate a suggested modification to the inserted text segment, to the context, or both, and presenting the suggested modification to a user in the user interface.

### BACKGROUND

This specification relates to processing data using machine learning models.

Machine learning models receive an input and generate an output, e.g., a predicted output, based on the received input. Some machine learning models are parametric models and generate the output based on the received input and on values of the parameters of the model.

Some machine learning models are deep models that employ multiple layers of models to generate an output for a received input. For example, a deep neural network is a deep machine learning model that includes an output layer and one or more hidden layers that each apply a non-linear transformation to a received input to generate an output.

### SUMMARY

This specification describes techniques for generating suggested modifications for pasted text using a trained neural network.

According to a first aspect, there is provided a method by one or more data processing apparatus that includes receiving information including a text segment to be inserted into a body of text displayed in a user interface; identifying a context, where the context is based on text surrounding the inserted text segment in the body of text; generating an input that includes the text segment and the context; processing the input using a trained neural network to generate a suggested modification to the inserted text segment, to the context, or both; and presenting the suggested modification to a user in the user interface.

In some implementations, presenting the suggested modification to the user in the user interface is based on a confidence score of the suggested modification.

In some implementations, presenting the suggested modification to the user in the user interface includes determining that the confidence score of the suggested modification exceeds a threshold, and, in response, presenting the suggested modification.

In some implementations, presenting the suggested modification to the user in the user interface includes automatically inserting the suggested modification in the body of text, where the suggested modification is in bold form.

In some implementations, presenting the suggested modification to the user in the user interface includes presenting the suggested modification in a color different than a color of the body of text, where the user can accept the suggested modification.

In some implementations, presenting the suggested modification to the user in the user interface includes indicating the suggested modification to the user as an icon that the user can inspect and determine whether to accept the suggested modification.

In some implementations, the body of text includes text from a source document corresponding to the text segment, text from a clipboard of the user interface, or both.

In some implementations, the trained neural network is a language model.

In some implementations, the suggested modification is in a domain-specific language.

In some implementations, the trained neural network has been trained on multiple training examples, each training example corresponding to an insertion event and including an original text segment that has been inserted into an original body of text, an original context including text surrounding the original text segment in the original body of text, and data identifying any edits that were made to the original text segment or the original context after the original text segment was inserted into the original text.

The subject matter described in this specification can be implemented in particular embodiments so as to realize one or more of the following advantages.

In conventional systems, a user can use a device to copy and paste (e.g., insert or replace) text into a body of text using an editor interface. For example, a user can paste code into a body of computer code displayed in a coding editor interface associated with a particular software programming language. In another example, a user can paste text into a body of text of natural language text displayed in a text editor interface.

In some cases, the user must modify the pasted text to adapt the pasted text to the body of text. For example, if a user pastes a portion of code into a body of code, the user may have to change variable names in one or more pasted lines of code in order to correctly adapt the portion of code to a context of the body of code. As another example, if a user pastes a portion of text into an electronic document, the user may need to manually adjust the formatting of the pasted text or the grammar or writing style of the pasted text to adapt the pasted text to the context of the electronic document. However, manually adapting the pasted text correctly to correspond to the context of the body of text can be time-consuming for the user, degrading the user experience and making it difficult to make use of the pasted text.

Some existing techniques for modifying text to adapt the pasted text to the context of the body of text include generating suggestions for additions of text. For example, a coding editor interface can suggest for a user to add code based on the pasted code. However, the suggestions for additions of text may not take the context of the body of text into consideration, requiring the user to accept or manually implement the suggested changes to the pasted text. This can also degrade user experience and counteract the intended purpose of streamlining user interface functionality, as the user may still have to manually adapt the text to correspond to the surrounding body of text.

In contrast, this specification describes techniques that allow for more efficient generation of suggested modifications for pasted text using a trained neural network. In particular, the system can generate suggested modifications to the pasted text based on identifying a context of the body of text surrounding the pasted text. The system can determine the context of the body of text, and the system can process the pasted text and the context using the trained neural network to generate a suggested modification to the pasted text, the context, or both. The system can then determine whether to present the suggested modification to the user. For example, the system can present the suggested modification to the user based on a confidence score of the suggested modification exceeding a threshold.

In some examples, the manner in which the system presents the suggested modification can be based on the extent of the suggested modifications. For example, if the suggested modifications are relatively minor, the system can automatically edit the body of text. In another example, if the suggested modifications are relatively larger, the system can present the suggested modification to the user such that the user can accept or reject the suggested modification. In this case, the system can present the suggested modification in color different than a color of the body of text, or the system can indicate the suggested modification to the user as an icon that the user can inspect and determine whether to accept the suggested modification.

Therefore, by generating the suggested modifications using a trained neural network, the system can more accurately suggest modifications to a user for pasted text, which allows for more efficient user interface functionality. Additionally, by applying or presenting the suggested modifications to the user based on the extent of the suggested modifications, the system can improve user experience by allowing the user to adapt pasted text in an expedited manner without having to manually modify the text.

The details of one or more embodiments of the subject matter of this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 shows an example system.

FIG. 2 is a block diagram of an input generation system for generating a network input based on inserted text in a body of text.

FIG. 3 illustrates examples of generated suggested modifications for a body of text.

FIG. 4 is a flow diagram of an example process for generating suggested modifications for a body of text using a trained neural network.

Like reference numbers and designations in the various drawings indicate like elements.

### DETAILED DESCRIPTION

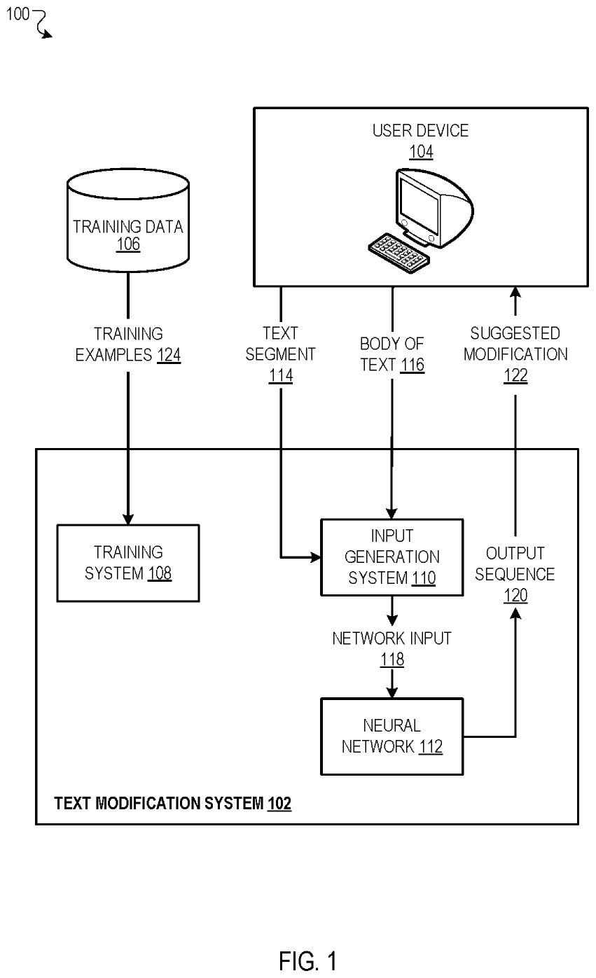

FIG. 1 shows an example system 100. The system 100 is an example of a system implemented as computer programs on one or more computers in one or more locations in which the systems, components, and techniques described below are implemented.

The system 100 includes a text modification system 102 configured to generate suggested modifications to pasted text in a user interface, training data 106 used to train the trained neural network 112, and a user device 104 in communication with the text modification system 102.

The text modification system 102 includes an input generation system 110 configured to generate an input (e.g., network input 118) to the trained neural network 112, the neural network 112 configured to process the network input 118 to generate an output sequence 120, and a training system 108 configured to train the neural network 112 to generate the output sequence 120 using training examples 124 from training data 106.

The trained neural network 112 can be a language model. A language model is a model that is trained to generate and understand human language.

Language models can be trained on datasets of text, code, or both and they can be used for a variety of tasks. For example, the language model can be pre-trained on a dataset of text prior to being trained on a dataset of code, as will be described below. As another example, the language model can be pre-trained on multiple code related tasks (e.g., code editing tasks) and then trained to generate suggested modifications to pasted code, as will be described below.

The language model can be any appropriate language model neural network that receives an input sequence made up of text tokens selected from a vocabulary and auto-regressively generates an output sequence made up of text tokens from the vocabulary. For example, the language model can be a Transformer-based language model neural network or a recurrent neural network-based language model. In this case, the language model can be trained to process an input of text tokens to generate the predicted output sequence 120 that includes text tokens conditioned on natural language, code, or both.

In some examples, the language model 170 can be a Transformer-based language model neural network or a recurrent neural network-based language model. In some situations, the language model 170 can be referred to as an auto-regressive neural network when the neural network used to implement the language model 170 auto-regressively generates the output sequence. More specifically, the auto-regressively generated output is created by generating each particular token in the output sequence conditioned on a current input sequence that includes any tokens that precede the particular text token in the output sequence.

To generate a particular token at a particular position within the output sequence, the language model can process the current input sequence to generate a score distribution, e.g., a probability distribution, that assigns a respective score, e.g., a respective probability, to each token in the vocabulary of tokens.

The neural network of the language model 170 can then select, as the particular token, a token from the vocabulary using the score distribution. For example, the neural network of the language model 170 can select the highest-scoring token or can sample a token from the distribution.

As a particular example, the language model 170 can be an auto-regressive Transformer-based neural network that includes multiple attention blocks that each apply a self-attention operation and an output subnetwork that processes an output of the last attention block to generate the score distribution. The language model 170 can have any of a variety of

Transformer-based neural network architectures. Generally, however, the Transformer-based neural network includes a sequence of attention blocks, and, during the processing of a given input, each attention block receives a respective input hidden state for each input token in the given input. The attention block then updates each of the hidden states at least in part by applying self-attention to generate a respective output hidden state for each of the input tokens. The input hidden states for the first attention block are embeddings of the input tokens in the input sequence and the input hidden states for each subsequent attention block are the output hidden states generated by the preceding attention block. The output subnetwork then processes the output hidden state generated by the last attention block in the sequence for the last input token in the input sequence to generate the output sequence.

The output sequence 120 can be a sequence of text tokens that represent one or more predicted modifications to the text segment 114, a context of the text segment 114, or both. The output sequence 120 can represent the one or more predicted modifications in a domain-specific language, such as natural language text or a programming language. The programming language can be a compiled programming language (e.g., C, C++, C#, COBOL, etc.) or an interpreted programming language (e.g., JavaScript, Perl, Python, BASIC, etc.).

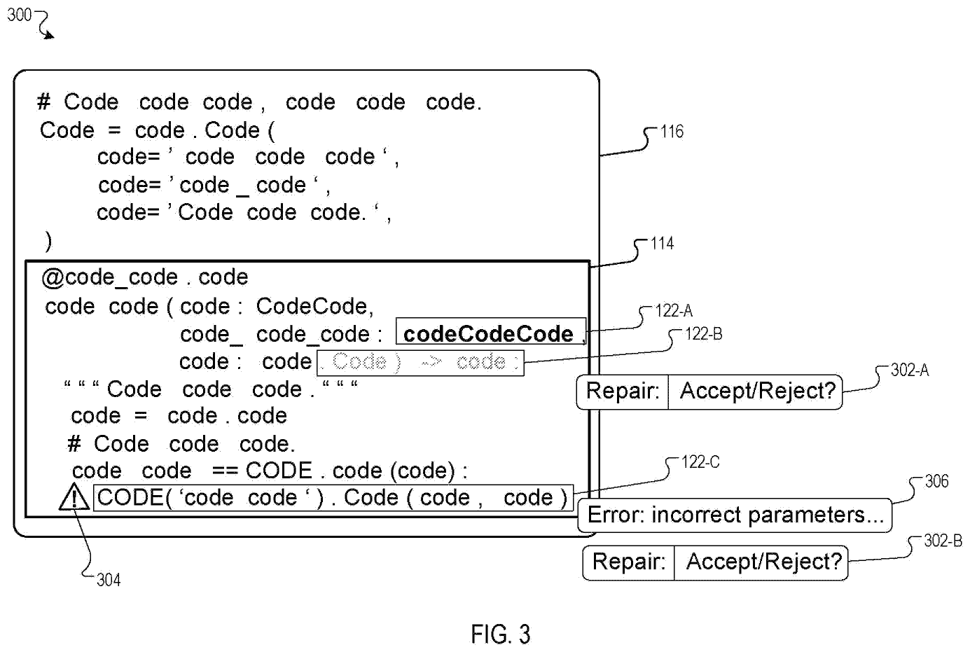

The system can determine whether to present the suggested modification(s) 122 defined by the output sequence 120 to the user as a suggested modification 122 based on a confidence score, user preferences, or both. Based on the system determining to present the suggested modification 122, the system selects an option for presenting the suggested modification based on an extent of the modifications, as described with more detail below with reference to FIG. 3.

In particular, the text modification system 102 is configured to receive a text segment 114 and a body of text 116 from the user device 104. The text segment 114 can be text to be inserted (e.g., pasted) into the body of text 116 displayed in a user interface of the user device 104. For example, the text segment 114 can be a code segment that the user has selected to paste into a body of code displayed in a user coding interface.

In some examples, the body of text 116 can include text from a source document corresponding to the text segment 114, text from a clipboard of the user interface, or both. The body of text 116 is in the same domain-specific language as the output sequence 120.

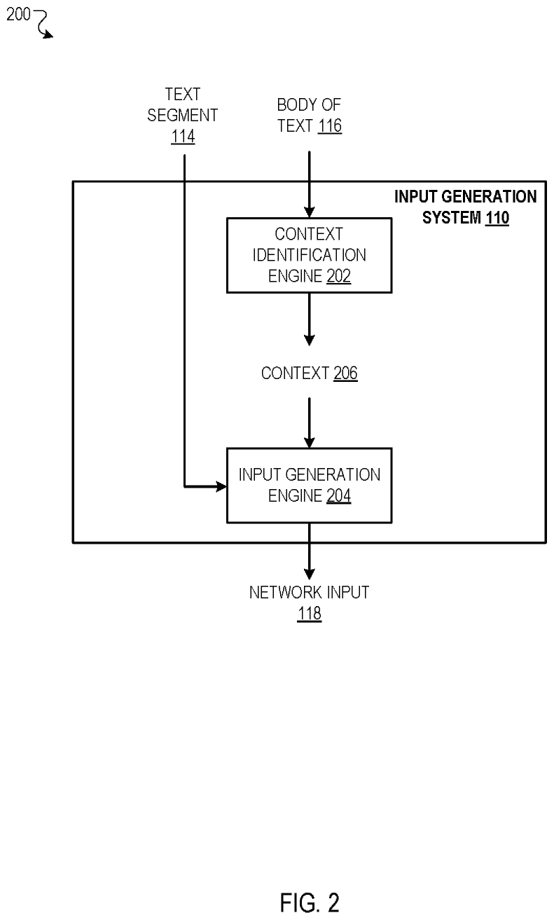

The text modification system 102 can identify a context of the text surrounding the pasted text segment 114 in the body of text 116, and text modification system 102 can process the text segment 114 and the context to generate the network input 118 as an input sequence of tokens, as described in further detail below with reference to FIG. 2.

The text modification system 102 can then process the network input 118 using the trained neural network 112 to generate the output sequence 120.

In some examples, the text modification system 102 can determine whether to present the output sequence 120 to the user as a suggested modification 122 based on a confidence score of the output sequence 120. The confidence score can be based on, e.g., the log likelihood of the probabilities assigned to each of the tokens of the output sequence by the neural network 112. In particular, the confidence score of the output sequence 120 must be higher than a threshold for the text modification system to determine to present the output sequence 120 to the user as the suggested modification 122 in the user interface.

Additionally, the text modification system 102 can select a way to present the suggested modification 122 to the user from one or more options.

The different options for presenting the suggested modification 122 can include automatically applying the suggested modification 122 by the system 100, or presenting the user with an option to accept or reject the suggested modification 122 at the user device. In some examples, the system can select one of the options for presenting the modification to the user based on an extent of the suggested modification 122, as described in further detail below with reference to FIGS. 2 and 3.

In this case, the extent of the suggested modifications 122 (e.g., how much the suggested modifications 122 edit the pasted text, the context, or both) can be based on a number of text characters that are modified (e.g., added, deleted, or changed). For example, the extent can be based on a ratio of modified characters to total characters or modified tokens to total characters, where the total characters are a sum of the characters of the pasted text and the characters of the context. The system can classify the extent into an extent class of one or more extent classes (e.g., relatively low extent, relatively moderate extent, relatively high extent, etc.) based on the ratio or the total modifications (e.g., the modified characters, the modified tokens, or both)

Prior to using the neural network 112, the training system 108 trains the neural network 112 to generate the output sequence 120 by processing the training examples 124. In some examples, the training system 108 can pretrain the LLM (e.g., the neural network 112) on the language modeling task of predicting, given an input sequence of text tokens from the training data 106, an output sequence 170 of tokens that follows the input sequence of text tokens. The system 100 can provide training examples 124 from the training data 106 to the training system 108 to train the neural network 112. The training examples 124 can be extracted from real world user logs of text editor interfaces or code editor interfaces. For example, the training system 108 can train the LLM (e.g., the neural network 112) on a log likelihood objective on a large dataset of training examples 124.

In particular, the training examples 124 each correspond to an insertion event (e.g., an event in which a user pasted text into a body of text). The training system 108 can identify an insertion event based on a number of text characters that are inserted into the body of text. For example, an insertion of a single text character is generally associated with a user manually inserting (e.g., typing) in the body of text, while an insertion of multiple text characters is generally associated with a user pasting text into the body of text.

The training examples 124 include the pasted text, an identified context of the body of text surrounding the pasted text, and identified modifications made to the pasted text, the context, or both after the insertion event occurred. The identified context is based on the body of text after the insertion event has taken place. In some examples, the training system 108 can identify the modifications based on a distance (e.g., a number of text lines) from the pasted text. For example, the training system 108 can identify modifications to the pasted text based on the modifications being within a certain distance of the pasted text. In some examples, the training system 108 can identify the modifications based on a time that a user applied the modifications. For example, the training system 108 can identify modifications to the pasted text based on the user modifying the pasted text within a particular timeframe of the insertion event (e.g., the user pasting the text).

FIG. 2 is a block diagram of the input generation system for generating a network input based on inserted text in a body of text using an input generation system, e.g., the input system generation system 110 described with reference to FIG. 1.

The system 110 includes a context identification engine 202 and an input generation engine 204.

The context identification engine 202 is configured to generate a context 206 by processing a body of text 116. In particular, the context identification engine 202 identifies contextual information associated with the body of text 116 surrounding the inserted text segment 114. For example, if a user pastes code into a body of code, the context identification engine 202 process the one or more lines of the body of code that surround the pasted code and identify one or more names of variables and one or more assigned values for the one or more variables as part of the context for the body of code. The location of the body of text 116 surrounding the pasted code can refer to a particular line of code, or a particular set of one or more tokens within the line of code.

The context identification engine 202 can then provide the context 206 to the input generation engine 204. The input generation engine 204 is configured to generate the network input 118 by processing the context 206 and the text segment 114 (e.g., the pasted text). In particular, the network input 118 is an input sequence of text tokens that represents the text segment 114 and the context 206. For example, the network input 118 can be an input sequence that includes tokens that represent one or more lines of code before the pasted code (e.g., text segment 114) in the body of code (e.g., the body of text 116), tokens that represent the pasted code, and token that represent one or more lines of code after the pasted code in the body of code.

In some examples, the input generation engine 204 can format the network input 118 to include one or more flags, where each flag is a token in the sequence of input tokens. For example, one of the flags can be positioned before the tokens representing the text segment 114 and another flag can be positioned after the tokens representing the text segment 114. For example, the network input 118 can include: <BEGIN> before the text segment 114 and <END> after the text segment 114.

In some examples, the network input 118 can include tokens that represent text from the body of text 116 that was replaced by the text segment 114 as part of the insertion event. For example, the network input can include: <BEFORE> referencing the replaced text. The training examples 124 can also be formatted as described.

The system 110 can provide the network input 118 to the trained neural network in order to generate the output sequence 120. The output sequence 120 is a sequence of text tokens that represent one or more modifications to the text segment 114, a context of the body of text, or both.

In particular, the output sequence 120 includes one or more tokens in the particular domain specific language that represent edits or annotations that can be displayed at the appropriate locations within the network input 118. In particular, the output sequence 120 can include tokens that identify an action (e.g., a modification to the text) and a pointer to a location in the text segment 114 or the context for applying the suggested modification.

The output sequence 120 can include tokens that represent a modification to multiple variable names located in certain lines of the pasted code in order to align with a context of the surrounding lines of code. In some examples, the output sequence 120 can include tokens for inserting tokens, deleting tokens from the pasted code, or renaming tokens from the pasted code. For example, for inserting tokens, the output sequence 120 can include: <INSERT><pointer-to-token-20>, followed by one or more tokens to be inserted. In another example, for deleting text, the output sequence 120 can include: <DELETE><pointer-to-token-42> or <DELETE>, followed by multiple pointers pointing to multiple tokens to be deleted. In another example, for renaming tokens, <RENAME><pointer-to-token-50> followed by a token for replacement.

The system can then determine whether to present the suggested modifications to the user based on the output sequence, and accordingly, in which way to present the suggested modifications, as described in further detail below with reference to FIG. 3.

FIG. 3 illustrates examples of generated suggested modifications for a body of text. The system, e.g., the text modification system 102 described with reference to FIG. 1, can process a network input, e.g., the network input described with reference to FIGS. 1 and 2, to generate a suggested modification.

The system 102 can process the network input 118 using the neural network 112 to generate the output sequence 120.

The system 102 then determines whether to output the output sequence 120 representing the modifications to the pasted text segment, the context, or both as a suggested modification 122 to the user on the user device 104. In some examples, the system determines to present the suggested modification 122 to the user based on a confidence score of the output sequence 120. For example, the neural network 112 can generate the output sequence 120 with an assigned confidence score (e.g., a log likelihood score) for each of the tokens of the output sequence 120, and the system determines whether to present the suggested modification 122 based on the confidence score satisfying a threshold.

In some examples, the system 102 can determine whether to present the suggested modification 122 to the user based on user preferences defined by the user. For example, the user preferences can include to refrain from presenting the suggested modification 122 to the user if the suggested modification 122 includes undoing or removing the entire text segment 114. In another example, the user preference can include to refrain from presenting the suggested modification 122 to the user for relatively large insertion events (e.g., large text segments 114 based on a number of text characters).

In some examples, the system 102 can implement one or more classifiers that can determine a relevance of the output sequence 120 or a user experience metric associated with the output sequence 120. For example, the system 102 can include a classifier that is trained on training data that includes modifications that were accepted by users and modifications that were rejected by users, and the classifier can generate a likelihood that a user will accept or reject a modification by processing the suggested modification. The system 102 can then determine whether to present the suggested modification based on the likelihood, e.g., based on whether the likelihood exceeds a threshold value.

In another example, the system can include a classifier that predicts the amount of time required for a user to manually modify the text or code (e.g., typing times) to implement the suggested modification. For example, the classifier can be trained on data that reflects typing times for users to implement modifications to text segments.

In this case, the system 102 can use the classifier to process the suggested modification to generate a user experience metric that predicts a trade-off between the amount of time required for the user to review the suggested modification to determine whether to accept or reject the modification and a prediction generated by the classifier of the time required for the user to manually implement the suggested modification. The system 102 can then determine whether to present the suggested modification based on the user experience metric, e.g., based on whether the metric indicates that it would take longer for the user to review the modification than to manually implement the modification. That is, the system 102 can determine to present the suggested modification only if the metric indicates that it would not take longer for the user to review the modification than to manually implement the modification.

Based on the system 102 determining to present suggested modification 122, the system 102 can select an option for presenting the suggested modification 122 to a user on the user device 104.

For example, the system 102 can select an option for presenting the suggested modification 122 based on an extent of the modification, where the options can include automatically applying the modification or allowing the user to accept or reject the modification. The extent of the modification is based on a number of edited text characters of the text segment 114, the context, or both. As another example, the system 102 can select the option for presenting the suggested modification based on user preferences.

For example, if the extent of the modification is relatively low, the system 102 can select an option to automatically insert the suggested modification 122-A in the body of text 116. In particular, the system 102 can determine that the suggested modification 122-A has a relatively low extent, and the system 102 can automatically insert the suggested modification 122-A in bold form without input from the user. In some cases, the system 102 can refrain from automatically inserting the suggested modification 122-A based on user preferences. For example, the user preference can include for the system 102 to refrain from automatically inserting the suggested modification 122-A if the suggested modification 122-A is not visible to the user on the user interface.

In another example, if the extent of the modification is relatively moderate or relatively high, the system 102 can present the suggested modification to the user, and the user can accept or reject the modification.

In particular, if the extent of the modification is relatively moderate, the system can present the suggested modification 122-B to the user in a color different than the color of the body of text 116, and the user can accept or reject the suggested modification 122-B using a control 302-A of the user interface. For example, the system 102 can determine that the suggested modification 122-B has a relatively moderate extent, and the system can present the suggested modification 122-B in a red color that contrasts with a color of the body of text 116, such as a blue color. The user can then select whether to accept or reject the suggested modification 122-B by selecting an option of the control 302-A. In some cases, the user can accept the suggested modification 122-B using a key of a keyboard of the user device 104 (e.g., by tapping the “Tab” key of the keyboard).

In another example, if the extent of the modification is relatively high, the system 102 can present the suggested modification 122-C to the user by indicating the suggested modification 122-C with an icon 304 that the user can inspect (e.g., select), and the user can accept or reject the suggested modification 122-C using a control 302-B of the user interface. Based on the user selecting the icon 304, the system 102 can present an error message 306 to the user that describes errors associated with the pasted text based on the context, such as incorrect parameters or incorrect variable names. The user can inspect the error message 306 and accept or reject the suggested modification 122-C using the control 302-A of the user interface.

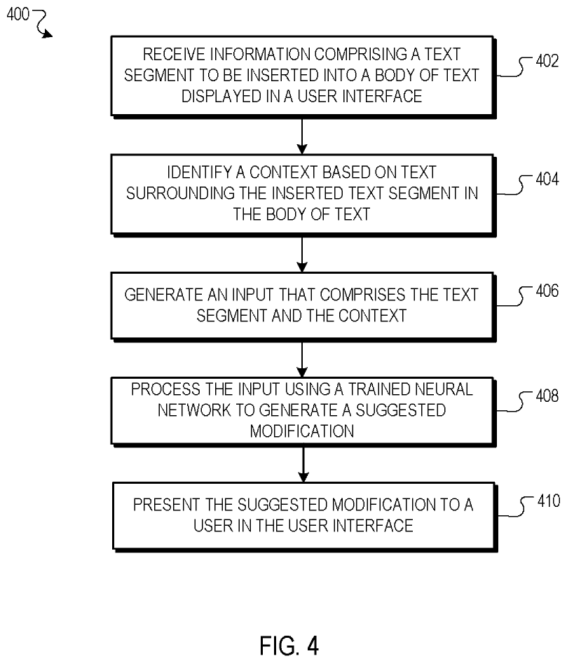

FIG. 4 is a flow diagram of an example process 400 for generating suggested modifications for a body of text using a trained neural network.

For convenience, the process 400 will be described as being performed by one or more data processing apparatus. For example, a system, e.g., the text modification system 102 of FIG. 1, appropriately configured in accordance with this specification, can perform the process 400.

The system receives information including a text segment to be inserted into a body of text displayed in a user interface (402). For example, a user can paste text into a body of text, such as code, in a coding interface. The system can receive the pasted text as an input.

The system then identifies a context based on text surrounding the inserted text segment in the body of text (404). For example, the context is based on the lines of code surrounding the pasted code.

The system generates an input that includes the text segment and the context (406). For example, the system generates the input by formatting the input to include the pasted code and the context of the code surrounding the pasted code.

The system then processes the input using a trained neural network to generate a suggested modification (408). The suggested modification can be a modification to the text segment, the context, or both. For example, the suggested modification can be a modification to a variable name of the pasted code.

The system presents the suggested modification to a user in the user interface (410). For example, the system can present the modification to the user in a color different than the color of the body of code, and the user can select whether to accept or reject the modification using a control of the user interface.

This specification uses the term “configured” in connection with systems and computer program components. For a system of one or more computers to be configured to perform particular operations or actions means that the system has installed on it software, firmware, hardware, or a combination of them that in operation cause the system to perform the operations or actions. For one or more computer programs to be configured to perform particular operations or actions means that the one or more programs include instructions that, when executed by data processing apparatus, cause the apparatus to perform the operations or actions.

Embodiments of the subject matter and the functional operations described in this specification can be implemented in digital electronic circuitry, in tangibly-embodied computer software or firmware, in computer hardware, including the structures disclosed in this specification and their structural equivalents, or in combinations of one or more of them. Embodiments of the subject matter described in this specification can be implemented as one or more computer programs, i.e., one or more modules of computer program instructions encoded on a tangible storage medium, which may be non-transitory, for execution by, or to control the operation of, data processing apparatus. The computer storage medium can be a machine-readable storage device, a machine-readable storage substrate, a random or serial access memory device, or a combination of one or more of them. Alternatively or in addition, the program instructions can be encoded on an artificially-generated propagated signal, e.g., a machine-generated electrical, optical, or electromagnetic signal, that is generated to encode information for transmission to suitable receiver apparatus for execution by a data processing apparatus.

The term “data processing apparatus” refers to data processing hardware and encompasses all kinds of apparatus, devices, and machines for processing data, including by way of example a programmable processor, a computer, or multiple processors or computers. The apparatus can also be, or further include, special purpose logic circuitry, e.g., an FPGA (field programmable gate array) or an ASIC (application-specific integrated circuit). The apparatus can optionally include, in addition to hardware, code that creates an execution environment for computer programs, e.g., code that constitutes processor firmware, a protocol stack, a database management system, an operating system, or a combination of one or more of them.

A computer program, which may also be referred to or described as a program, software, a software application, an app, a module, a software module, a script, or code, can be written in any form of programming language, including compiled or interpreted languages, or declarative or procedural languages; and it can be deployed in any form, including as a stand-alone program or as a module, component, subroutine, or other unit suitable for use in a computing environment. A program may, but need not, correspond to a file in a file system. A program can be stored in a portion of a file that holds other programs or data, e.g., one or more scripts stored in a markup language document, in a single file dedicated to the program in question, or in multiple coordinated files, e.g., files that store one or more modules, sub-programs, or portions of code. A computer program can be deployed to be executed on one computer or on multiple computers that are located at one site or distributed across multiple sites and interconnected by a data communication network.

In this specification the term “engine” is used broadly to refer to a software-based system, subsystem, or process that is programmed to perform one or more specific functions. Generally, an engine will be implemented as one or more software modules or components, installed on one or more computers in one or more locations. In some cases, one or more computers will be dedicated to a particular engine; in other cases, multiple engines can be installed and running on the same computer or computers.

The processes and logic flows described in this specification can be performed by one or more programmable computers executing one or more computer programs to perform functions by operating on input data and generating output. The processes and logic flows can also be performed by special purpose logic circuitry, e.g., an FPGA or an ASIC, or by a combination of special purpose logic circuitry and one or more programmed computers.

Computers suitable for the execution of a computer program can be based on general or special purpose microprocessors or both, or any other kind of central processing unit. Generally, a central processing unit will receive instructions and data from a read-only memory or a random access memory or both. The essential elements of a computer are a central processing unit for performing or executing instructions and one or more memory devices for storing instructions and data. The central processing unit and the memory can be supplemented by, or incorporated in, special purpose logic circuitry. Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device, e.g., a universal serial bus (USB) flash drive, to name just a few.

Computer-readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's device in response to requests received from the web browser. Also, a computer can interact with a user by sending text messages or other forms of message to a personal device, e.g., a smartphone that is running a messaging application, and receiving responsive messages from the user in return.

Data processing apparatus for implementing machine learning models can also include, for example, special-purpose hardware accelerator units for processing common and compute-intensive parts of machine learning training or production, i.e., inference, workloads.

Machine learning models can be implemented and deployed using a machine learning framework, e.g., a TensorFlow framework.

Embodiments of the subject matter described in this specification can be implemented in a computing system that includes a back-end component, e.g., as a data server, or that includes a middleware component, e.g., an application server, or that includes a front-end component, e.g., a client computer having a graphical user interface, a web browser, or an app through which a user can interact with an implementation of the subject matter described in this specification, or any combination of one or more such back-end, middleware, or front-end components. The components of the system can be interconnected by any form or medium of digital data communication, e.g., a communication network. Examples of communication networks include a local area network (LAN) and a wide area network (WAN), e.g., the Internet.

The computing system can include clients and servers. A client and server are generally remote from each other and typically interact through a communication network. The relationship of client and server arises by virtue of computer programs running on the respective computers and having a client-server relationship to each other. In some embodiments, a server transmits data, e.g., an HTML page, to a user device, e.g., for purposes of displaying data to and receiving user input from a user interacting with the device, which acts as a client. Data generated at the user device, e.g., a result of the user interaction, can be received at the server from the device.

While this specification contains many specific implementation details, these should not be construed as limitations on the scope of any invention or on the scope of what may be claimed, but rather as descriptions of features that may be specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially be claimed as such, one or more features from a claimed combination can in some cases be excised from the combination, and the claimed combination may be directed to a subcombination or variation of a subcombination.

Similarly, while operations are depicted in the drawings and recited in the claims in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system modules and components in the embodiments described above should not be understood as requiring such separation in all embodiments, and it should be understood that the described program components and systems can generally be integrated together in a single software product or packaged into multiple software products.

Particular embodiments of the subject matter have been described. Other embodiments are within the scope of the following claims. For example, the actions recited in the claims can be performed in a different order and still achieve desirable results. As one example, the processes depicted in the accompanying figures do not necessarily require the particular order shown, or sequential order, to achieve desirable results. In some cases, multitasking and parallel processing may be advantageous.

What is claimed is:

1. A computer-implemented method, comprising:
receiving information comprising a text segment to be inserted into a body of text displayed in a user interface;
identifying a context, wherein the context is based at least in part on text surrounding the inserted text segment in the body of text;
generating an input that comprises the text segment and the context;
processing the input using a trained neural network to generate a suggested modification to the inserted text segment, to the context, or both; and
presenting the suggested modification to a user in the user interface.

2. The computer-implemented method of claim 1, wherein presenting the suggested modification to the user in the user interface is based at least in part on a confidence score of the suggested modification.

3. The computer-implemented method of claim 2, wherein presenting the suggested modification to the user in the user interface comprises:
determining that the confidence score of the suggested modification exceeds a threshold; and
in response, presenting the suggested modification.

4. The computer-implemented method of claim 1, wherein presenting the suggested modification to the user in the user interface further comprises:
automatically inserting the suggested modification in the body of text, wherein the suggested modification is in bold form.

5. The computer-implemented method of claim 1, wherein presenting the suggested modification to the user in the user interface further comprises:
presenting the suggested modification in a color different than a color of the body of text, wherein the user can accept the suggested modification.

6. The computer-implemented method of claim 1, wherein presenting the suggested modification to the user in the user interface further comprises:
indicating the suggested modification to the user as an icon that the user can inspect and determine whether to accept the suggested modification.

7. The computer implemented method of claim 1, wherein the body of text comprises text from a source document corresponding to the text segment, text from a clipboard of the user interface, or both.

8. The computer implemented method of claim 1, wherein the trained neural network is a language model.

9. The computer implemented method of claim 1, wherein the suggested modification is in a domain-specific language.

10. The computer-implemented method of claim 1, wherein the trained neural network has been trained on a plurality of training examples, each training example corresponding to an insertion event and comprising:
an original text segment that has been inserted into an original body of text;
an original context comprising text surrounding the original text segment in the original body of text; and
data identifying any edits that were made to the original text segment or the original context after the original text segment was inserted into the original body of text.

11. A system comprising one or more computers and one or more storage devices storing instructions that are operable, when executed by the one or more computers, to cause the one or more computers to perform the operations comprising:
receiving information comprising a text segment to be inserted into a body of text displayed in a user interface;
identifying a context, wherein the context is based at least in part on text surrounding the inserted text segment in the body of text;
generating an input that comprises the text segment and the context;
processing the input using a trained neural network to generate a suggested modification to the inserted text segment, to the context, or both; and
presenting the suggested modification to a user in the user interface.

12. The system of claim 11, wherein presenting the suggested modification to the user in the user interface is based at least in part on a confidence score of the suggested modification.

13. The system of claim 12, wherein presenting the suggested modification to the user in the user interface comprises:
determining that the confidence score of the suggested modification exceeds a threshold; and
in response, presenting the suggested modification.

14. The system of claim 11, wherein presenting the suggested modification to the user in the user interface further comprises:
automatically inserting the suggested modification in the body of text, wherein the suggested modification is in bold form.

15. The system of claim 11, wherein presenting the suggested modification to the user in the user interface further comprises:
presenting the suggested modification in a color different than a color of the body of text, wherein the user can accept the suggested modification.

16. One or more computer storage media storing instructions that when executed by one or more computers cause the one or more computers to perform operations comprising:
receiving information comprising a text segment to be inserted into a body of text displayed in a user interface;
identifying a context, wherein the context is based at least in part on text surrounding the inserted text segment in the body of text;
generating an input that comprises the text segment and the context;
processing the input using a trained neural network to generate a suggested modification to the inserted text segment, to the context, or both; and
presenting the suggested modification to a user in the user interface.

17. The one or more computer storage media storing instructions of claim 16, wherein presenting the suggested modification to the user in the user interface is based at least in part on a confidence score of the suggested modification.

18. The one or more computer storage media storing instructions of claim 17, wherein presenting the suggested modification to the user in the user interface comprises:
determining that the confidence score of the suggested modification exceeds a threshold; and
in response, presenting the suggested modification.

19. The one or more computer storage media storing instructions of claim 16, wherein presenting the suggested modification to the user in the user interface further comprises:
automatically inserting the suggested modification in the body of text, wherein the suggested modification is in bold form.

20. The one or more computer storage media storing instructions of claim 16, wherein presenting the suggested modification to the user in the user interface further comprises:
presenting the suggested modification in a color different than a color of the body of text, wherein the user can accept the suggested modification.
